(19) United States
(12) Patent Application Publication
(10) Pub. No.: US 2018/0255968 A1
(43) Pub. Date: Sep. 13, 2018

(54) CONTINUOUS GRILL AND COOKING METHOD

(71) Applicant: Guenther HERTEL, Wendelstein (DE)

(72) Inventors: Werner KUHLMANN, Wendelstein (DE); Guenther HERTEL, Wendelstein (DE)

(73) Assignee: Guenther HERTEL, Wendelstein (DE)

(21) Appl. No.: 15/760,724

(22) PCT Filed: Sep. 16, 2016
(86) PCT No.: PCT/DE2016/100434

§ 371 Date: Apr. 6, 2018

(30) Foreign Application Priority Data
Sep. 18, 2015 (DE) 10 2015 115 813.2
Jul. 18, 2016 (DE) 10 2016 113 199.7

(51) Int. Cl. A47J 37/04; A23L 5/10

(52) U.S. Cl. CPC A47J 37/041; A23V 2002/00; A47J 2202/00; A23L 5/15

(57) ABSTRACT

A continuous grill with at least two grill rollers forming at least one grilling gap, in one aspect, includes an assembly capable of rotating relative to and projecting out of or into at least one roller. An inner rotary bearing is disposed between this roller and assembly and/or this assembly is mounted on a housing of the grill or on a carrier group mounted immovably relative to the housing. In another aspect, the grill includes at least one electrically designed and/or locally measuring thermometer disposed inside at least one roller. In a further aspect, the grill includes at least one roller coated with a non-stick coating or enameled. A method for cooking of products for grilling on a continuous grill regulates the speed of throughput of the product for grilling through the gap and/or the temperature of at least one roller as a function of certain parameters.

The invention relates to a continuous grill with at least two grill rollers forming at least one grilling gap as well as to a method for cooking products for grilling on such a continuous grill.

Grills and cooking methods of the class in question are known, for example, from EP 0 092 046 A1, from DE 82 11 327 U1, from DE 81 19 752 U1, from DE 38 02 345 C1, from DE 37 27 679 A1, from EP 0 053 656 A1 or from DE 38 16 474 C1, and have a grilling gap, through which product for grilling is passed, and becomes grilled while it is passing through the grilling gap.

These continuous grills often comprise grill rollers, which function for the transport or the guidance of the product for grilling, wherein these grill rollers—depending on specific configuration of the continuous grill—may be designed to be driven or to idle. Likewise these grill rollers, depending on specific configuration of the continuous grill, may be heated, which preferably may be achieved by a heating unit disposed inside the respective grill rollers.

However, such grills appear to be unmarketable for the moment, since they have completely disappeared from the market.

It is the task of the present invention to configure a continuous grill with at least two grill rollers forming at least one grilling gap as well as a method for cooking of products for grilling on such a continuous grill, in such a way that its marketability is enhanced.

In this connection, the invention starts from the basic knowledge that the marketability of continuous grills may be enhanced if they or a corresponding cooking method achieve good cooking results even with different products for grilling.

The task of the invention is accomplished by continuous grills or cooking methods having the features of the independent claims. Further advantageous embodiments, which as the case may be are also independent thereof, are specified in the dependent claims as well as in the following description.

Thus a continuous grill with at least two, preferably three grill rollers forming at least one grilling gap may be characterized in that an inner rotary bearing is disposed between at least one of the grill rollers and an assembly projecting out of it and/or projecting into it and capable of rotating relative to this grill roller, or in that the continuous grill comprises an assembly that is capable of rotating relative to at least one of the grill rollers and that projects out of this grill roller and/or projects into this grill roller, wherein an inner rotary bearing is disposed between this grill roller and this assembly. This inner rotary bearing, in suitable configuration, may permit an exact positioning of the assembly capable of rotating relative to the grill roller, which accordingly may make the action of this assembly more precise, so that the continuous grill, with suitable activation, is able to adapt precisely to different product for grilling, which ultimately then enhances its marketability.

In particular, it is conceivable to provide, at both ends of the corresponding grill roller, an inner rotary bearing, which may then function to position this assembly as well as possible relative to the grill roller. It will be understood that different assemblies, which project into the grill roller or project out of it and are mounted accordingly, may also be provided if necessary at each of the ends of the grill roller.

Alternatively thereto or cumulatively therewith, a continuous grill with at least two, preferably three grill rollers forming at least one grilling gap may be characterized in that the continuous grill comprises an assembly that is capable of rotating relative to at least one of the grill rollers and that projects out of this grill roller and/or projects into it, wherein this assembly is mounted on a housing of the continuous grill or on a carrier group mounted immovably relative to the housing. Similarly to the inner rotary bearing, with suitable configuration an exact positioning of the assembly capable of rotating relative to the grill roller may also be permitted by such a carrier group, which accordingly may make the action of this assembly more precise, so that the continuous grill, with suitable activation, is able to adapt precisely to different product for grilling, which ultimately then enhances its marketability.

The exact positioning can hardly be achieved, for example, with assemblies revolving together with the grill roller, since the corresponding assembly then rotates with the grill roller and does not remain positioned exactly relative to the product for grilling or cooking.

The corresponding assembly may comprise, for example, a heating unit and/or a thermometer, wherein the corresponding assembly may if necessary also comprise a carrier element for the heating unit or the thermometer. Likewise, the assembly may comprise a carrier element for other components that are to be positioned inside the corresponding grill roller.

The carrier group, which may then, for example, carry the aforesaid assemblies, such as the heating unit and/or the thermometer or even the carrier element, may be in particular a retaining bracket or arm, since such a retaining bracket or arm may be easily fastened and equipped with further fastening elements, for example for the assembly.

A very good positioning of the corresponding grill roller relative to the grilling gap or relative to the rest of the continuous grill may be assured in that a corresponding grill roller is mounted rotatably via an outer rotary bearing on a housing of the continuous grill. Such an outer rotary bearing may also be provided in particular at both ends of the at least one grill roller. Naturally an outer grill bearing is provided with a relatively large diameter, so that it is able to counteract large moments, such as tilting moments, for example, better than with a smaller diameter. Hereby the stability of the overall arrangement may be increased commensurately.

In the use of an outer rotary bearing, then accordingly, via the inner rotary bearing, the assembly capable of rotating relative to the grill roller and projecting into it or projecting out of it may be mounted via the inner rotary bearing, so that further retaining forces, which could be additionally necessary for an exact positioning of this assembly, are reduced to a minimum. Such retaining forces may then be used additionally, for example to select the rotary position of the assembly relative to the grill roller and, as opposed to the rotating grill roller, for example, to hold this assembly immovably relative to the housing, for which purpose—naturally—the carrier group explained in the foregoing may also be used.

On the other hand, it is also conceivable to connect the assembly projecting out of the grill roller and/or projecting into it and being capable of rotating relative to this grill roller relatively stiffly with the housing of the continuous grill or to construct a corresponding carrier group relatively stably, so that substantial bearing forces for the grill roller are supplied via the inner rotary bearing, which correspondingly relieves an outer rotary bearing or makes it possible to dispense with an outer rotary bearing. Instead of this, it is then possible, for example, to provide only a seal or even only a seal gap, which correspondingly reduces to a minimum any cleaning work that could be required in particular for a change of the product for cooking, for example between fish and meat.

Preferably at least one of the rotary bearings is a sliding bearing, in which case it will be understood that rolling bearings may also be used as the rotary bearings if necessary instead of a sliding bearing. Under the given circumstances, however, especially in relation to the robustness and the stability even under temperature fluctuations as they naturally occur in a continuous grill, sliding bearings accordingly appear to be advantageous.

Preferably the mounting takes place via an insulating unit. In this way, a transfer, between the corresponding grill roller, the assembly projecting into or projecting out of the grill roller and the rest of the grill, of any heat that may be present may be reduced to a minimum, which is of advantage in particular when the assembly projecting into or out of the grill roller comprises a heating unit, in order to reduce the heat load on the rest of the grill and especially any bearings, or when the assembly projecting into or projecting out of the grill roller is to be protected from a heat load, for example due to the grill roller or from heat due to a heating unit provided in some other way.

The insulating unit may be realized in particular via an insulating layer, wherein other measures, such as insulating sleeves or point contacts, for example, may also be employed accordingly for this purpose.

A continuous grill with at least two, preferably three grill rollers forming at least one grilling gap may also be characterized by at least one heating unit comprising a heating cartridge, disposed inside at least one of the grill rollers. In the present connection, a heating cartridge denotes a self-contained arrangement with two electrical terminals, through which a heating current may be passed through the heating cartridge, which may be prefabricated as a compact and inherently stable unit and positioned in desired manner. The use of a heating cartridge has the advantage that it may be positioned relatively precisely inside the respective grill roller, so that it may be ensured that good cooking results can be achieved even with different product for grilling, which accordingly enhances the marketability. In appropriate configuration, such heating cartridges also permit a facilitation with respect to the maintenance activities, since the heating cartridges are relatively insensitive and may be handled simply and operationally safely. In particular, the fact that heating cartridges usually have the electrical terminals on one side facilitates the activation of the heating cartridge, since all electrical terminals have to be provided on only one side.

The use of a heating cartridge is indeed inherently advantageous, even independently of the other features of the present invention. However, the inner rotary bearing or the carrier group permits a correspondingly precise positioning of the heating cartridge, and so especially the combination with one or both of these suggested approaches is cumulatively advantageous. Furthermore, in suitable configuration, the advantage is achieved that the electrical terminals of the heating cartridge do not necessarily have to run via sliding contacts, since they must transmit relatively high power.

Preferably, the heating cartridge is spaced apart from the grill roller by less than the half inside radius of the grill roller in which the heating cartridge is disposed. This correspondingly increases the heat transmission that is possible to the grill roller. Depending on specific implementation of the present invention, this spacing may be provided only at one place, which accordingly leads to a pinpoint or to a local heating of the grill roller, when this is desired. Preferably, however, the corresponding spacing, at least in a sub-region of the grill roller that is to be loaded with product for grilling, is constant or varies by less than five per cent in the section perpendicular to the axis of revolution of the grill roller. Hereby a correspondingly uniform heating of the grill roller may be ensured.

Preferably, the heating cartridge is spaced apart from the grill roller by less than 10% of the inside radius of the grill roller, especially less than 8% of the inside radius of the grill roller.

In particular, in order to ensure a uniform heating of the grill roller, a continuous annular gap, which preferably is continuously clear and preferably varies by less than 5% in its clearance spacing, may be disposed between the grill roller and the heating cartridge.

Preferably, the heating cartridge is made from cast aluminum, which in particular ensures very uniform heating of the heating cartridge. It will be understood that the use of such a heating cartridge is correspondingly advantageous for the heating unit inside a grill roller of a continuous grill, even independently of the other features of the present invention.

In order to achieve good cooking results even with different product for grilling, a continuous grill with at least two, preferably three grill rollers forming at least one grilling gap may be characterized cumulatively with or alternatively to the other features of the present invention by at least one electrically designed thermometer disposed inside one of the grill rollers. A thermometer designed in such a way permits a very good and precise sensing of the respective temperature, so that a correspondingly good measured result may also be used for a more accurate activation of a heating unit or of the speed of rotation of the grill rollers of the continuous grill, which accordingly permits an adaptation to different product for grilling and to its different physical properties.

Good cooking results can also be achieved with different product for grilling, when a continuous grill with at least two, preferably three grill rollers forming at least one grilling gap is characterized cumulatively with or alternatively to the other features of the present invention by at least one locally measuring thermometer disposed inside one of the grill rollers. Such a locally measuring thermometer accordingly permits the sensing of the temperature at locally one place, which leads to correspondingly more accurate results, which is not possible by integrating temperature gauges, such as represented by expansion rods, for example.

Resistance thermometers or thermocouples, which in particular are relatively small-structured and also are able to measure with high precision, are suitable in particular as thermometers.

The thermometer may also comprise a heat-sensitive color-changing area on an inside wall of the grill roller. Such color-changing areas are known, for example, from frying pans or electric grills, and by their color change show an observer when the temperature has risen above or fallen below a particular threshold.

For example, via a color sensor inside the grill roller, such a color change may be determined and used for the temperature measurement.

The measured result of the thermometer may be used on the one hand for activation of the heating unit or of the rotational speed of the grill rollers, in order to be able to operate the continuous grill at a desired temperature. Likewise, the measured result may be used for other purposes, such as, for example, the indication to a user that the operating temperature has been reached or that the temperature has fallen below a cleaning temperature, after which a cleaning is possible without problems. In this way, a temperature-induced damage by cleaning agents, whether they are of chemical or biological nature or are mechanical cleaning agents, can be reduced to a minimum.

In order to achieve good cooking results even with different products for grilling, a continuous grill with at least two, preferably three grill rollers forming at least one grilling gap may be characterized by at least one locally active heating unit disposed inside at least one of the grill rollers. Hereby the position at which the corresponding grill roller is then heated will be individually predetermined, so that optimum heating results can be achieved for different product for grilling. In particular, several such locally active heating units may be provided, so that the heating position, in which specific heating units may be switched on or off or operated with different temperatures, can be correspondingly adapted individually.

Good cooking results can also be achieved with different product for grilling, when a continuous grill with at least two, preferably three grill rollers forming at least one grilling gap is characterized by at least one regulable heating unit disposed inside at least one of the grill rollers. In departures from heating systems in which the heating power can only be switched on or off, a regulable heating unit ensures that the temperatures can be matched much more finely and to the respective product for cooking.

It will be understood that the aforesaid advantages do not necessarily always have to be implemented, although corresponding advantages then have to be sacrificed if applicable. On the other hand, it will be understood that the locally active and/or the regulable heating unit may also be combined for use with the other features of the present invention, which is the case in particular for an electrically designed and/or locally measuring thermometer.

Thus the locally active heating unit may have several heating bars or a heating cartridge disposed eccentrically relative to the respective of the grill rollers, whereby selective local heating of the respective grill roller can be achieved in structurally simple manner.

As already explained in the foregoing, it is of advantage when the heating cartridge is formed from cast aluminum, which permits an outstandingly uniform temperature distribution at the surface of the heating cartridge, so that this may be effectively used in locally selective manner.

In particular, an electrically designed thermometer in interaction with a regulable heating unit permits a very good and accurate temperature control of the heating unit and accordingly also of any grill rollers that may be present, and respectively a very precise thermal exposure of the product for grilling or cooking. This is the case in particular when different product for grilling or cooking is to be grilled or cooked, since fish or poultry, for example, are grilled or cooked better at temperatures other than for pork or beef.

In particular, the thermometer may be attached on or in the heating unit, so that the temperature of the heating unit can be measured very accurately and if necessary also regulated. Depending on specific requirements, the thermometer may be disposed on the surface of the heating unit, so that the temperature of the grill roller may also be measured in given manner, or else in the inside of the heating unit, for example even cast in the heating cartridge, so that the temperature of the heating unit can be sensed very accurately.

The heating cartridge may have respectively a bearing point, especially at its ends, so that it can be positioned operationally safely and precisely relative to the respective grill roller. In this connection, the bearing points may cooperate with the rotary bearings explained in the foregoing and/or with the carrier groups explained in the foregoing. Preferably, the heating cartridges have one or more electrical terminals only at one of their ends, such as, for example, for a current inlet and outlet or else for one or more thermometers. This ensures that all associated assemblies, such as a power supply, any electronic unit that may be necessary for operation of the thermometer, any regulating unit or control device that may be necessary, can be disposed only on one side of the grill roller or of the grilling gap, and complex cable layouts can be avoided.

Furthermore, good cooking results can be achieved with different product for grilling, even independently of the other features of the present invention, when a continuous grill with at least two, preferably three grill rollers forming at least one grilling gap is characterized by at least one grill roller coated with a non-stick coating or enameled. Hereby residues of products for grilling remain on the grill roller to a reduced extent or hardly at all, so that different product for grilling can be passed in succession through the continuous grill without relatively great effort and with good cooking results. An appropriate non-stick coating or an enameling also ensures that the respective grill roller can be cleaned quickly and simply.

The non-stick coating may in particular be a Teflon® coating, which is particularly well established in the prior art as a non-stick coating. In particular, the Teflon® coating may contain a color indicator, as is already known from the prior art for frying pans or electric grills. Such a color indicator is already capable on the one hand of indicating to the eye of the user when a particular temperature has been reached, for example a sufficiently high grilling temperature or a sufficiently low cleaning temperature. On the other hand, it is likewise conceivable to monitor such a color indicator via a color sensor, so that corresponding information is sensed instrumentally and is available for an electronic or processor-controlled further processing.

As the color indicator, it is possible on the one hand to use color-changing systems, which change only between two colors. Likewise, however, color indicators are also known that pass through a color spectrum as a function of the temperature.

It will be understood that an appropriate non-stick coating may be used, especially also cumulatively with the other features of the present invention, and this in particular with a color sensor and any cleaning methods that may be necessary.

A continuous grill with at least two, preferably three grill rollers forming at least one grilling gap may also be characterized by means for monitoring the grilling gap, in order to be able to achieve good cooking results with different product for grilling. Such monitoring means may be used to obtain information about the presence of product for grilling or about its consistency or nature. Thus such monitoring means may comprise, for example, a torque-sensing unit, which senses a change of torque at the grill rollers and draws corresponding conclusions on the basis of this change. Thus the torque change may make is possible to draw conclusions directly as to the presence of product for grilling or as to its absence, so that the temperature behavior can be appropriately activated in this respect. A change of the torque may also yield conclusions as to the thickness of the product for grilling, since—naturally—thicker product for grilling causes a greater torque for given grilling gap. Furthermore, the monitoring means may comprise an ultrasonic sensor, which on the one hand is able to measure directly the presence of products for grilling or even particular material properties. Cumulatively with or alternatively to this, the monitoring means may comprise a pressure sensor, which is able to measure a specific pressure on the grill rollers or on at least one grill roller and in this way to conclude as to the presence or absence of product for grilling or as to its thickness. Preferably, at least one of the sensors of the monitoring means is designed as a proximity sensor, so that the presence of product for grilling, to be introduced into the grilling gap, is sensed as early as possible and if necessary an adaptation of the temperature of the continuous grill can already be undertaken preemptively.

It will be understood that such monitoring means may be appropriately used cumulatively with or alternatively to the other features of the present invention. In particular, cumulative advantages may be achieved here in interplay with a speed-regulating unit and/or a temperature-regulating unit for the grill rollers.

If a continuous grill with at least two, preferably three grill rollers forming at least one grilling gap is characterized by at least one grill roller with different diameters, good cooking results can be achieved respectively with different product for grilling, especially when it has different thicknesses. By a grill roller with different diameters, it is possible in structurally simple manner to provide different gap thicknesses of the grilling gap, so that thicker product for grilling can be introduced into a region with a broader grilling gap, while thinner product for grilling can be introduced into a gap with narrower diameter. In this way, correspondingly good cooking results can be achieved respectively with different thicknesses of the product for grilling.

A grill roller with different diameters may be conically structured, for example, although structurally this is relatively complex to implement, since the different speeds of rotation, which are imposed respectively by the different radii, lead to uncontrolled forces on the product for grilling. The gradual change of diameter of the grill roller also causes a piece of the product for grilling to be grilled on the one side with a narrow diameter and on the other side with a larger diameter when the grilling gap is changed. To this extent, it is of advantage when the grill roller having the different diameters is provided with at least two sub-rollers with different diameters, wherein these sub-rollers, in a preferred embodiment, are respectively constructed cylindrically, so that a constant gap diameter for the product for grilling is also accordingly available over a particular length of the grilling gap, namely the length of the corresponding sub-roller. In this way, a good cooking result can be respectively achieved in structurally particularly simple manner with different product for grilling.

It will be understood that a grill roller with different diameters is correspondingly advantageous both independently of the other features of the present invention and also in combination therewith.

In order to be able to achieve good cooking results operationally safely with different product for grilling, it is of advantage when the continuous grill comprises an electronic unit, by which, for example, a grill-roller drive or a heating unit can be activated adaptively to respectively the different product for grilling. However, the electronic unit may also be used if necessary merely to ensure a particularly uniform operation of the grill-roller drive or to activate a heating unit of the continuous grill in desired manner.

However, it has been found that such an electronic unit is relatively temperature-sensitive, and so correspondingly it proves advantageous when a continuous grill with at least two, preferably three grill rollers forming at least one grilling gap is characterized by a split housing, in the one sub-housing of which at least one grill-roller drive, especially a motor, is disposed, and in the other sub-housing of which at least electronic unit is disposed in order to be able to achieve good cooking results with different product for grilling.

Merely the division of the housing makes it possible to reduce the temperature exposure for the electronic unit, which may then be implemented simply in particular when the sub-housing in which the electronic unit is disposed is situated as far as possible from the grill rollers.

It will be understood that the housing may if necessary have further sub-housings, such as a housing for the grill rollers, for example. In a particularly preferred arrangement, the sub-housing in which the grill-roller drive is disposed serves as the partition from the grill rollers and therefore the insulating unit of the sub-housing in which the electronic unit is disposed.

Further reductions of thermal stress can be achieved by the insulating unit already described in the foregoing. Even the electrical terminals provided respectively on one side of a heating cartridge are advantageous here, since then measures for thermal insulation have to be provided only on the corresponding housing sides.

It will be understood that the subdivision of the housing into sub-housings is correspondingly advantageous even independently of the other features, although especially a combination with the other approaches explained here also achieves correspondingly cumulative advantages.

Accordingly, it is of advantage when at least one of the sub-housings is cooled. In fact, relatively complex cooling mechanisms may be provided here if necessary, such as cooling coils or a Peltier cooling unit. However, an air-cooling unit, which may be provided in particular by a fan, appears to be particularly structurally simple.

In order to reduce, to a minimum, any odors, which in particular could possibly even cause flavor changes in the presence of different product for grilling, a continuous grill with at least two, preferably three grill rollers forming at least one grilling gap may be characterized cumulatively with or alternatively to the other features of the present invention by at least one exhaust unit acting on the grilling gap.

This exhaust unit may be disposed inside the housing, for example, and in this way correspondingly extract odors and flying cooking residues from the grilling gap. From the inside of the housing, the exhaust unit may then extract from the grilling gap without difficulty.

Preferably, the housing is closed except for an inlet leading into the grilling gap and an outlet leading out of the grilling gap, so that a presence of residual air is reduced to a minimum and the exhaust unit is able to act effectively on the grilling gap.

Preferably, this exhaust unit is dimensioned such that an adequate air stream through the inlet and the outlet can be ensured in the housing, while allowing for any leakage points in the housing, for example such as slits between cover plates, miniature openings in the region of threads or rivets or the like.

On the one hand, the exhaust unit may discharge into an exhaust-air duct, in order in this way to reduce odors or a contamination of another product for grilling to a minimum. Depending on specific configuration, this exhaust-air duct may discharge into further exhaust-air ducts that exit a building. Likewise, it is conceivable to allow the exhaust-air duct to end in a sub-housing, for example, in order to use the exhaust air there additionally as cooling air, although this depends in particular on the temperature regime of the continuous grill, for example on whether the temperatures in the sub-housing into which the exhaust-air duct discharges are higher than in the grilling gap, taking into consideration the air stream caused by the exhaust unit and the incoming stream of cooler outside air.

Preferably, the exhaust unit leads the extracted air through one or even several filters or through another cleaning device. In this way a contamination of downstream assemblies can be reduced to a minimum, which is the case in particular when the extracted air is to be guided into a sub-housing or into the housing for cooling purposes or for other purposes. However, even a combination of the environment of the continuous grill or any downstream exhaust-air ducts that may be present can be reduced to a minimum in this way.

The continuous grill may have means for varying the grilling gap. This may be achieved, for example, by varying the diameter of the grill rollers, although this is constructively relatively complex. A change of location of the grill rollers relative to one another, which depending on specific type of location change leads to a corresponding change of the grilling gap, proves much simpler. Thus, for example, at least one of the grill rollers may be constricted to be displaceable along a guide path. It is particularly preferred when this guide path is circular and the center of the circle lies on an axis of a drive shaft of the corresponding grill roller, so that the drive of the respective grill roller does not also have to be further correspondingly entrained.

If necessary, the size of the grilling gap, which if appropriate may be measured or sensed via the varying means or else even via the monitoring means explained in the foregoing, may be used for regulation of the speed of throughput of the product for grilling or the speed of revolution of at least one of the grill rollers and/or for regulation of the temperature of at least one of the grill rollers or of an associated heating unit, which leads to an inexpensive implementation of the continuous grill, especially because of the multiple utilization of corresponding assemblies.

Good cooking results with different product for grilling may be achieved by a method for cooking of products for grilling on a continuous grill with at least two, preferably three grill rollers forming at least one grilling gap, when this is characterized in that the speed of throughput of the product for grilling through the grilling gap is regulated as a function of the type of product for grilling, of a roller contact pressure, of the size of the grilling gap and/or of a temperature measurement. Both the roller contact pressure and the size of the grilling gap or the temperature measurement provide, in structurally simple manner, individually and especially jointly, significant items of information about the instantaneous condition of the continuous grill, so that the effect on the product for grilling can be adapted simply and precisely to the respective product for grilling via the throughput speed. Depending on specific implementation, a temperature regulation of the continuous grill, i.e. especially of any grill rollers that may be present, when these contain a heating unit, may be undertaken cumulatively with or alternatively thereto.

To this extent, good cooking results with different product for grilling can also be achieved by a method for cooking of product for grilling on a continuous grill with at least two, preferably three grill rollers forming at least one grilling gap, when this is characterized in that the temperature of at least one of the grill rollers is regulated as a function of the type of product for grilling, of a roller contact pressure, of the size of the grilling gap and/or of a speed of throughput of the product for grilling through the grilling gap.

This temperature measurement may comprise in particular a locally measuring thermometer or a heat-sensitive color-changing area, which may be sensed accordingly by a color sensor, which is structurally simple to implement and accordingly permits precise temperature indications.

It will be understood that the color change may if necessary display different colors as a function of temperature or may include different areas that react color-sensitively to various temperatures.

In this connection, it may be ensured via the temperature of the grill roller, which ultimately comes directly into contact with the surface of the product for cooking, that a sufficient quantity of energy is input into the product for cooking without damaging the surface of the product for cooking, especially by burns, while on the other hand the total quantity of energy that reaches the product for cooking and therefore defines the cooking process even in the interior may be defined via the roller speed.

In fact, measuring methods are also conceivable via which it is possible to identify the type of product for grilling that has been introduced respectively into the continuous grill. This may be achieved, for example, via optical sensors or even via chemical sensors. However, such measuring methods still seem highly complex at the present time, and so it is of advantage to indicate the type of product for grilling via input means provided on the continuous grill. With this input, it is then possible, for example, to adapt the temperature or else the throughput speed appropriately to the product for grilling, in which case it is possible in this respect to consider still further variables here, such as, for example, the roller contact pressure of the grill rollers or the size of the grilling gap with its information capacity with respect to the thickness of the product for grilling or product for cooking.

Accordingly, it is advantageous cumulatively with or alternatively to the other features of the present invention when a continuous grill with at least two, preferably three grill rollers forming at least one grilling gap is characterized a regulation of the speed of the products for grilling through the grilling gap or of the rolling speed of at least one grill roller as a function of the type of products for grilling, of a roller contact pressure, of the size of the grilling gap (13) and/or of a temperature measurement. It is also advantageous cumulatively with or alternatively to the other features of the present invention when a continuous grill with at least two, preferably three grill rollers forming at least one grilling gap is characterized by a regulation of the temperature of at least one of the grill rollers as a function of the type of product for grilling, of a roller contact pressure, of the size of the grilling gap and/or of a speed of throughput of the product for grilling through the grilling gap.

Before an end of the cooking process, at least one of the grill rollers may revolve without heating and a mechanical cleaning means, such as a cleaning sponge, a cleaning brush or a cleaning pad may be passed along the grill roller as it continues to revolve. In this way, cooking residues may be removed rapidly and operationally safely, so that, on the one hand, hygienic requirements but also any flavor contaminations on different products for grilling can be prevented operationally safely.

If necessary, the grill roller may be provided with a reversal of direction relative to the direction of revolution used with the grill in operation, in order to enhance cleaning effects.

Cleaning brushes have the advantage in particular that if necessary they may also bear constantly on the grill roller or may be structurally integrated into the continuous grill, even if they are then brought up to the respective separating roller via a corresponding positioning mechanism only for cleaning purposes.

Preferably, the cleaning takes place only in the case that the temperature has fallen below a cleaning-temperature limit, so that an impairment of the cleaning means can be avoided. In this connection, it is of advantage when the continuous grill displays when the temperature has fallen below the cleaning-temperature limit, so that it can be indicated in operationally safe manner to the operating personnel or to a user when the temperature has fallen below the cleaning-temperature limit.

It will be understood that the features of the approaches described in the foregoing or in the claims may also be combined as the case may be, in order to be able to implement the advantages correspondingly cumulatively.

Further advantages, objectives and properties of the present invention will be explained on the basis of following description of exemplary embodiments, which in particular are also illustrated in the attached drawing, wherein:

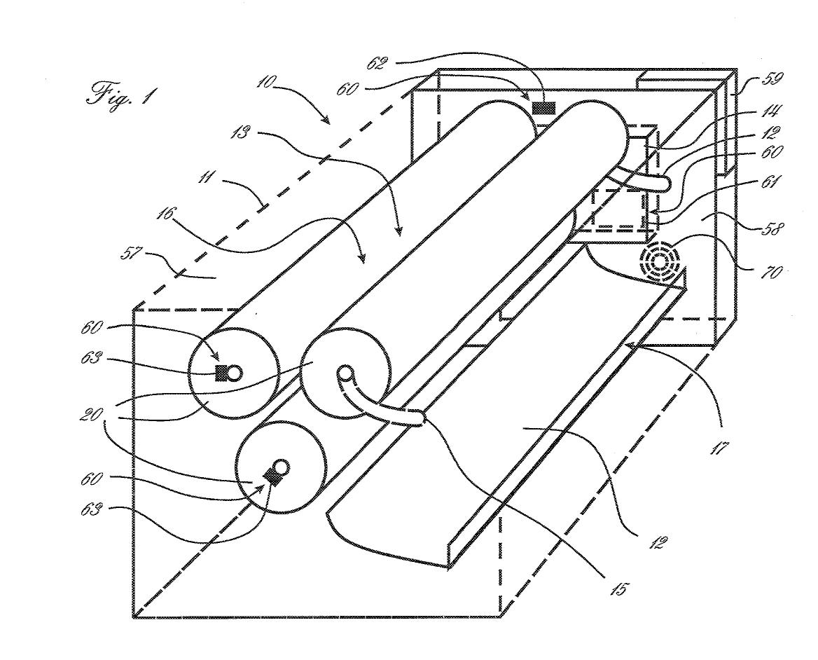

FIG. 1 shows a perspective schematic view of a continuous grill;

FIG. 2 shows two schematic sections through a first grill roller;

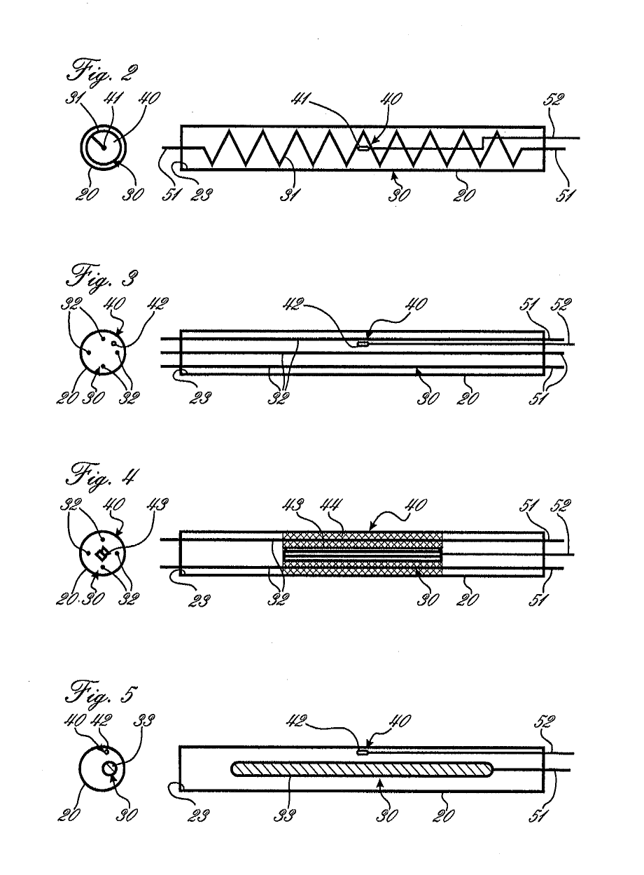

FIG. 3 shows two schematic sections through a second grill roller;

FIG. 4 shows two schematic sections through a third grill roller;

FIG. 5 shows two schematic sections through a fourth grill roller;

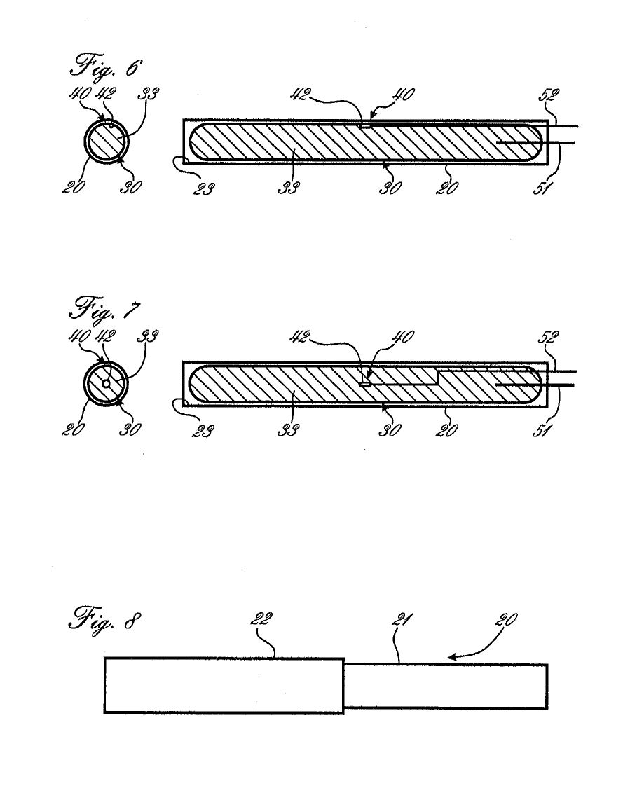

FIG. 6 shows two schematic sections through a fifth grill roller;

FIG. 7 shows two schematic sections through a sixth grill roller;

FIG. 8 shows a schematic side view of a seventh grill roller;

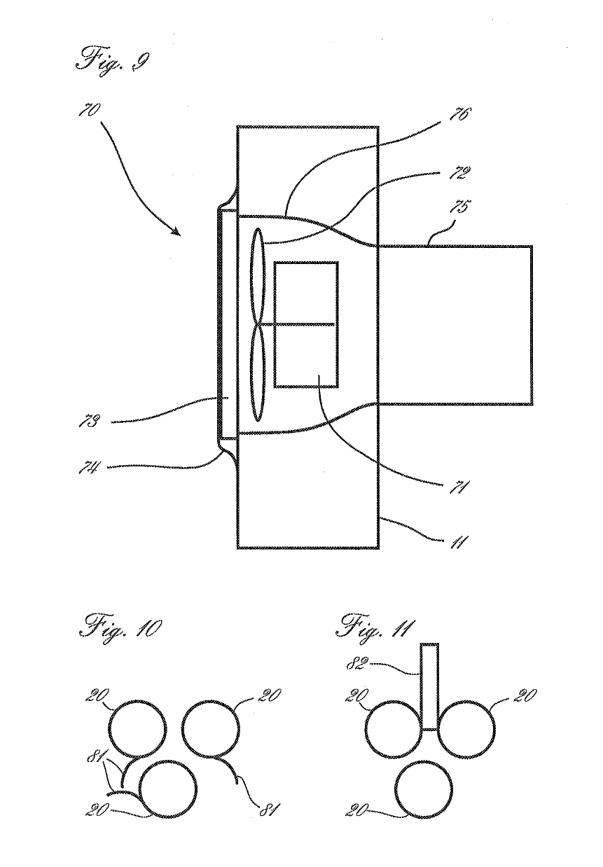

FIG. 9 shows a schematic detail view of the exhaust unit;

FIG. 10 shows a schematic cross section through a continuous grill with first mechanical cleaning means;

FIG. 11 shows a schematic cross section through a continuous grill with second mechanical cleaning means;

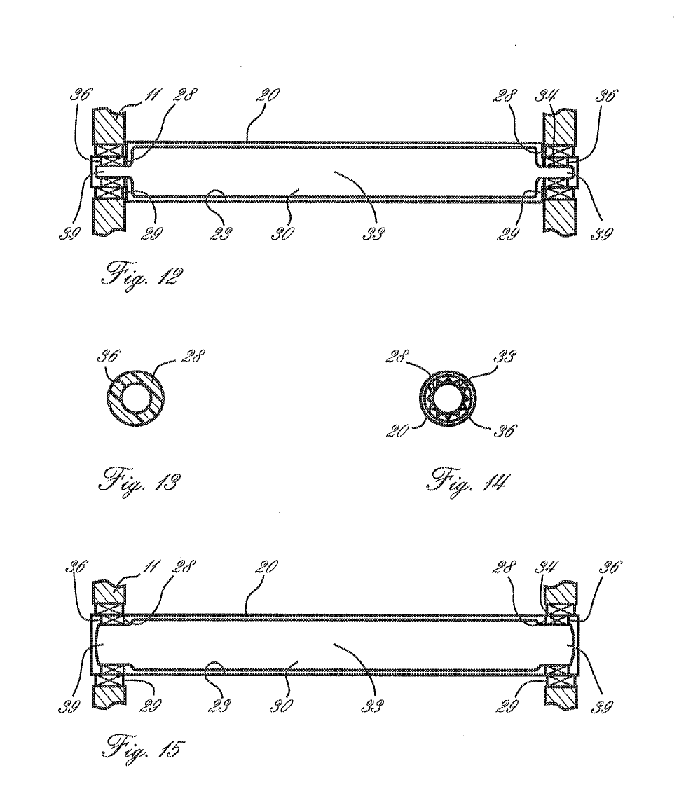

FIG. 12 shows a schematic side view of an eighth grill roller;

FIG. 13 shows a schematic elevation view of a rotary bearing;

FIG. 14 shows a schematic elevation view of a further rotary bearing;

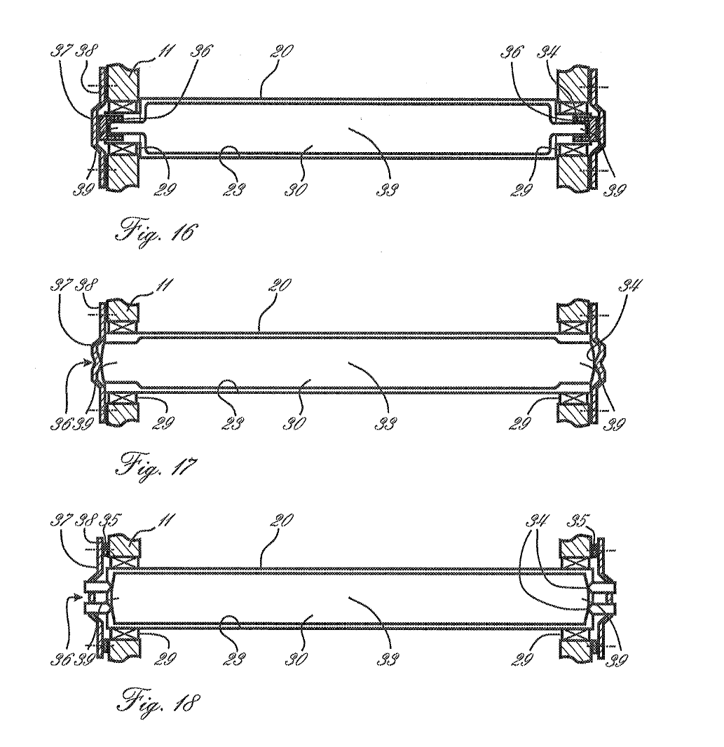

FIG. 15 shows a schematic side view of a ninth grill roller;

FIG. 16 shows a schematic side view of a tenth grill roller;

FIG. 17 shows a schematic side view of an eleventh grill roller;

FIG. 18 shows a schematic side view of a twelfth grill roller;

FIG. 19 shows a schematic diagram of grilling-gap varying means; and

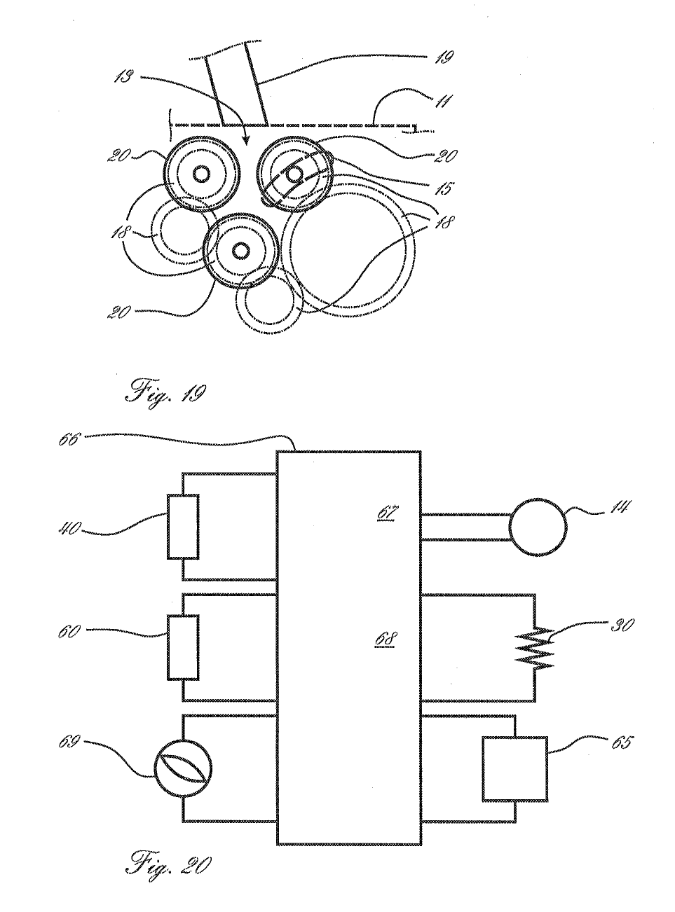

FIG. 20 shows a schematic diagram of a regulating unit for continuous grills.

The continuous grill 10 illustrated schematically in FIG. 1 has three grill rollers 20, which are disposed in a housing 11.

The grill rollers 20 form a grilling gap 13, through which product for grilling, which is introduced from above into the grilling gap 13 in an inlet 16, is able to pass, in order that when grilled it then exits therefrom at an outlet 17 and arrives on a discharge grate 12, from which it may then be removed from the continuous grill 10.

One of the grill rollers 20 is displaceable along a guide path representing grilling-gap varying means 15, so that in this way the grilling gap 13 can be adapted to product for grilling with different thickness. Alternative grilling-gap varying means 15 are shown by way of example in FIG. 19.

The grill rollers 20 are driven via a schematically illustrated motor 14.

The motor 14 drives toothed gears 18, which in turn drive the grill rollers 20, as illustrated by way of example in FIG. 19. The axis of rotation of the large toothed gear 18 of FIG. 19 corresponds to the axis of revolution around which the grilling-gap varying means 15 displace the corresponding roller 20, so that the rotary forces can be transmitted simply and without complication. In a selected embodiment, this roller 20 may be biased in the gap symbolizing the grilling-gap varying means 15 via a spring in the direction of the other grill roller 20, so that the adaptation of the grilling gap 13 to the product for grilling takes place automatically. The deflection is then a direct measure of the thickness of the product for grilling or of grilling gap 13.

The motor 14 is equipped with a torque-sensing unit 61 (schematically illustrated), which monitoring means 60 represent, by way of which the grilling gap 13 can be monitored for the presence of product for grilling in the grilling gap 13. Likewise an ultrasonic sensor 62, which as monitoring means 60 monitors the grilling gap 13 with ultrasound for any product for grilling that may be present, is provided on the housing 11. Furthermore, the monitoring means 60 further comprise pressure sensors 63, which measure any pressure that product for grilling present in the grilling gap 13 may exert on two of the grill rollers 20. Any measuring means that may be present for measurement of the thickness of the grilling gap 13, for example via the grilling-gap varying means 15, may also be used as monitoring means 60. It will be understood that, if necessary, different embodiments may dispense with some or all of the monitoring means 60.

As illustrated by way of example in FIG. 19, a feeder 19 for product for grilling, which in the manner of a sliding guide delivers product for grilling or cooking to the grilling gap 13, when the latter is fed to the feeder 19 for product for grilling, may be mounted on the housing 11. In particular, several individual pieces of product for grilling or cooking may be stocked in a feeder 19 for product for grilling that is adequately large-dimensioned, and then delivered successively to the grilling gap 13 by gravity. In alternative embodiments, the feeder 19 for product for grilling may also be joined solidly to the housing 11.

The housing 11 comprises three sub-housings 57, 58, 59, of which the grill rollers 20 are disposed in one sub-housing 57, whereas the motor 14 is located in the second sub-housing 58. The third sub-housing 59 is spaced apart from the grill rollers 20 by the second sub-housing 58 and serves in particular as the enclosure for electronic unit 66 (see FIG. 20), which in this way is insulated via sub-housing 58 from the grill rollers 20 and from the temperatures induced by these in the continuous grill 10.

Furthermore, the continuous grill 10 has an exhaust unit 70 (see FIGS. 1 and 9), which extends into the sub-housing 57 and serves to extract air from the grilling gap 13 or from the sub-housing 57, in order in this way to reduce odors or any potential contaminations to a minimum.

As illustrated in particular in FIG. 9, the exhaust unit 70 comprises a fan 72, driven by a fan motor 71, which extracts air from the grilling gap 13 or from the sub-housing 57 through a metallic filter 73, which is held by a filter holder 74. For this purpose, the fan 72 is situated in an exhaust duct 76, which leads through the housing 11 to an exhaust-air duct 75, which can be connected from outside. Via the exhaust-air duct 75, the air may then be removed to the outside, in order in this way to reduce an odor contamination.

In a different embodiment, provided a sufficient cleaning takes place by the filter 73 and the air sucked in is not too hot due to the air flow, the exhaust duct 76 may discharge into the sub-housing 58 or into the sub-housing 59, in order in this way to permit an air cooling of these sub-housings 58, 59.

The exhaust unit 70 is dimensioned such that an adequate air stream through the inlet 16 and the outlet 17 can be ensured in the housing 11, while allowing for any leakage points that may be present in the housing 11, for example such as slits between cover plates, miniature openings in the region and threads or rivets or the like.

Depending on specific construction of the continuous grill 10, the grill rollers 20 may be heated or unheated. Different configurations are also conceivable with respect to the nature of the heating unit.

Thus, as illustrated by way of example in FIG. 2, at least one of the grill rollers 20 may be equipped with a heating unit 30 in the form of a heating coil, which is disposed helically inside the grill roller 20. A thermometer 40, which is formed as resistance thermometer 41 in the exemplary embodiment illustrated in FIG. 2, may also be is disposed in the grill roller 20. In the exemplary embodiment illustrated in FIG. 2, the thermometer 40 is situated in the middle of the grill roller 20, although—depending on specific requirements—another location may also be selected here, if a corresponding temperature sensing is desired. It will be understood in particular that several thermometers may also be provided if necessary, especially even different thermometers, which are positioned appropriately.

As an example, however, heating bars 32, as illustrated by way of example in FIG. 3, may also be used as heating unit 30. In this exemplary embodiment, four heating bars 32 are disposed in the grill roller 20, parallel to one another and parallel to the axial direction of the grill roller 20. In this exemplary embodiment, they are aligned equidistant to one another, although in other embodiments a nonuniform distribution may also be selected if necessary, if a correspondingly nonuniform distribution of the temperature is also desired.

In the exemplary embodiment illustrated in FIG. 3, a thermocouple 42, which is situated on a central plane, although not at the center but instead in the vicinity of an inner wall 23 of the grill roller 20, in order to be able to measure the temperature there locally as accurately as possible, is disposed as thermometer 40 inside the grill roller 20. It will be understood that, in a different embodiment, another thermometer 40 may be selected here also. In particular, it is also conceivable to dispose thermometer 40 elsewhere or even to provide several thermometers 40.

The heating unit of the exemplary embodiment according to FIG. 4 corresponds substantially to the heating unit 30 of the exemplary embodiment according to FIG. 3. As thermometer 40, however, a color-changing area 44, which changes its color when the temperature rises above or falls below a temperature limit, is disposed on the inside wall 23 of the grill roller 20. The color inversion or the color change may be sensed via a color sensor 43, which is disposed inside the grill roller 20 and is directed toward the color-changing area. In the present exemplary embodiment, the color inversion or the color change is provided at a temperature above which grilling is possible.

In the grill rollers 20 illustrated in FIGS. 5 to 7, a heating cartridge 33 is respectively used as heating unit 30. In the exemplary embodiment illustrated in FIG. 5, the heating cartridge 33 is relatively small and eccentrically disposed, so that the distance to the inside wall 23 of the grill roller 20 is shorter than the half inside radius of the grill roller 20.

In contrast, the heating cartridge 33 of the heating unit 30 according to FIGS. 6 and 7 is configured to be much larger and to leave a continuous annular gap, amounting to eight per cent of the inside radius of the grill roller 20, relative to the inside wall 23 of the grill roller 20.

In the exemplary embodiment according to FIG. 6, the thermometer 40, which in this exemplary embodiment is formed as thermocouple 42, is situated on the heating cartridge 33. In view of the very small annular gap relative to the inside wall 23 of the grill roller 20, it can be assumed that this thermocouple 42 is also able to measure the temperature at the inside wall 23 of the grill roller 20 relatively accurately, by the fact that the thermocouple 42 is thermally insulated as well as possible inwardly toward the heating cartridge 33.

In the exemplary embodiment according to FIG. 7, the thermocouple 42 is cast in the heating cartridge 33, and so the temperature of the heating cartridge 33 can be measured very accurately and then this can also be regulated effectively in its temperature with a corresponding electronic unit, such as electronic unit 66, or temperature-regulating unit 68.

In the exemplary embodiment according to FIG. 5, the thermocouple is disposed in self-supported manner in the vicinity of the inside wall.

The thermometer 40 and the heating units 30 are respectively supplied with energy via electrical terminals 51, 52, which project out of the grill rollers 20, or are connected to the electronic unit 66 or to another electronic control unit.

In this connection, the electrical terminals 51, 52 in the exemplary embodiments illustrated in FIGS. 5 to 7 are respectively situated at one end of the respective heating unit 30 or heating cartridge 33, so that these may also be connected easily to the electronic unit 66 on the corresponding housing side. It will be understood that the exemplary embodiments illustrated in FIGS. 2 to 4 may also be configured in such a way by heating coils 31 appropriately laid in loops or by heating bars 32.

Via the thermometers 40, which in these exemplary embodiments are all configured electrically and measure locally, the temperature of the heating unit 30 and/or the speed of revolution of the grill rollers 20 may—depending on specific activation—be regulated, for which purpose the electronic unit 66 with its speed-regulating unit 67 and its temperature-regulating unit 68 is used (see FIG. 20). This regulation can be achieved much more reliably than is the case with known integrating measuring thermometers, such as represented by expansion rods, for example. It will be understood, however, that such integrating measuring thermometers 40 or other non-electrically acting thermometers may also be used in different embodiments.

Depending on specific implementation, the embodiments illustrated in FIGS. 2 to 7 may be combined or varied, by interchanging the heating units 30 and the thermometers 40 or positioning them differently.

Under some circumstances, a variation of the grilling gap via the grilling-gap varying means 15 illustrated by way of example in FIG. 1 is very complex and undesired, and so a grill roller 20 comprising two sub-rollers 21, 22 may be used if necessary, as illustrated by way of example in FIG. 8. These two sub-rollers 21, 22 have different diameters and are otherwise, however, configured cylindrically, which accordingly leads, in interplay with the other grill roller 20, to a varying grilling gap 13.

As illustrated in FIG. 10, cleaning brushes 81 may bear scrapingly on grill rollers 20, which is advantageous in particular for grill rollers 20 of stainless steel. Residues of product for grilling that adhere to the grill roller 20 may then be scraped off and removed via the cleaning brushes 81.

Depending on specific embodiment, these cleaning brushes 81 may scrape constantly along the grill rollers 20 and thus perform their cleaning task constantly, or else may be constructed to be swung closed or open according to need.

Such cleaning brushes 81 may also be used, for example, for grill rollers 20 provided with an enamel layer.

However, the constant rubbing load appears to be too aggressive for grill rollers 20 provided with a non-stick coating, such as Teflon®, for example, and so a cleaning pad 82, for example, may be used here, as illustrated by way of example in FIG. 11. This may then be conveyed by the rotating grill rollers 20 along the grilling gap 13 and furnish its cleaning performance. In this connection, it is possible to match the material of the cleaning pad 82 to the surface of the respective grill rollers 20. Preferably, the cleaning takes place only when the temperature has fallen below a cleaning-temperature limit. As an example, this cleaning-temperature limit may be measured by the thermometers 40, as already described in the foregoing, and indicated to a user via the electronic unit 66 of the continuous grill 10 and a corresponding display 68 (see FIG. 20).

It will be understood that the direction of revolution of the grill rollers 20 may also be reversed for cleaning if necessary, when this seems advantageous.

In the arrangements schematically illustrated in FIGS. 6 and 7, it proves relatively difficult to position the heating cartridge 33 correctly relative to the grill roller 20. For this purpose, the heating cartridge 33 may have bearing journals 39 or bearing points 34 (numbered by way of example), by means of which the heating cartridge 33 is mounted rotatably via an inner rotary bearing 28 on the grill roller 20, as illustrated by way of example in FIGS. 12 and 15. This permits an extremely stable mounting of the heating unit 30 relative to the grill roller 20. Cumulatively or alternatively, a mounting of the heating cartridge 33 that is immovable relative to the housing 11 may be achieved via the bearing journals 39 or corresponding bearing points 34 on the heating cartridge 33, as is illustrated by way of example in FIGS. 16 to 18.

Depending on specific construction, a rolling bearing or a sliding bearing may be used as rotary bearing, in which case—as illustrated in particular in FIGS. 13 and 14—sliding bearings have proved to be particularly advantageous.

As an example, therefore, a plastic ring may be used as inner rotary bearing 28, as illustrated by way of example in FIG. 13. In particular, such a plastic ring may also act in thermally insulating manner or as insulating unit 36, especially with respect to the heating cartridge 33. In order to increase the thermal insulation capacity, it is also conceivable, for example, to equip the plastic ring with radial stays, so that potential heat conduction via the material is reduced.

In an embodiment that is different and illustrated schematically in FIG. 14, the surface of the grill roller 20 and the surface of the heating cartridge 33 slide directly on one another, wherein the region of the heating cartridge 33 that comes into contact with the grill roller 20 is equipped, as insulating unit 36, with radially inwardly directed recesses for a reduction of the heat transfer, so that only a very small contact area remains.

Depending on specific embodiment, the heating cartridge may, for example, also be fastened permanently in the housing 11 of the continuous grill 10 (see FIGS. 16 to 18), so that the grill roller 20 may also be stably mounted via the inner rotary bearing 28 and a further bearing for the grill roller 20 is not necessary.

Preferably, however, the grill roller 20 is mounted respectively via an outer rotary bearing 29 in the housing 11, so that, above all, the heating cartridge 33 is insulated as well as possible from the other assemblies of the continuous grill 10. Then it needs to be stabilized merely in its direction of revolution, which can already be achieved, for example, by the electrical terminals (not illustrated in FIG. 12), which may correspond in particular to the arrangements illustrated in FIGS. 6 and 7.

As is immediately obvious, a demounting of the arrangement of heating cartridge 33 and grill roller 20, as is illustrated in FIG. 12, is relatively complex, since roller journals of the grill roller 20 must be removed in order that the heating cartridge 33 can be pulled out of the grill roller 20 or pushed into it.

The arrangement according to FIG. 15 is helpful here, in which the grill roller 20 has a substantially cylindrical inside diameter, which is characterized in particular in that the ends of the grill roller 20 are larger in their diameter than the heating cartridge 33, so that this can be easily removed and inserted if necessary.

It will be understood that other or further assemblies, which are to be disposed inside the grill roller 20 may also be mounted or held if necessary via the inner rotary bearing 28.

The exemplary embodiment illustrated in FIG. 16 corresponds substantially to the exemplary embodiment according to FIG. 12, although the bearing journals 39 forming the bearing points 34 here are fastened in a sleeve (not separately numbered) functioning as insulating unit 36 on a retaining bracket 37, which functions as carrier group 38 for fastening on the housing 11.

In the exemplary embodiment illustrated in FIG. 17, a heating cartridge 33 corresponding to the exemplary embodiment of FIG. 15 is used, but its bearing journals 39 respectively have, in front of the ends of the heating cartridge 33, bearing points 34, via which the heating cartridge 33 is clamped with the retaining bracket 37 functioning as the carrier group 38. In this connection, the retaining brackets 37 interact with the heating cartridge 33 at a pinpoint position at the bearing points 34, so that a thermal resistance that acts as insulating unit 36 is formed here.

Similar pinpoint heat transitions are formed in the exemplary embodiment illustrated in FIG. 18 by threaded bolts (not numbered), which are screwed into the retaining brackets 37 likewise used there and are seated on bearing points 34 of the heating cartridge 33. Furthermore, insulating unit layers 35 in the form of plastic washers are additionally provided in this exemplary embodiment between the retaining bracket 37 or the carrier group 38 and the housing 11, in order to boost the insulating unit 36. It will be understood that other forms of insulating layers 35, such as films or lacquers or the like, may also be provided in different embodiments.

The heating cartridge 33 illustrated in FIG. 18 does not have any bearing journals 39 formed or molded-on separately, which in this embodiment merge cylindrically into the heating cartridge 33. It will be understood that, with suitable adaptation of the carrier group 33 and the retaining unit, other types of bearing points 34 or bearing journals 39 may also be used for this purpose.

The embodiments illustrated in FIGS. 16 to 18 may be combined without difficulty with the embodiments of FIGS. 12 to 15 when, for example, the carrier groups 38 and/or insulating units 36 of the embodiments illustrated in FIGS. 16 to 18 are added in the embodiments according to FIGS. 12 to 15 or when, for example, an inner rotary bearing is also used in the embodiments according to FIGS. 16 to 18, in which case the outer rotary bearing 29 may then be dispensed with if necessary.

In particular, the exemplary embodiments illustrated in FIGS. 12 to 18 may be equipped with electrical terminals, as are disclosed by way of example in FIGS. 5 to 7, in which case the electrical terminals may if necessary be routed through or past the respective retaining brackets 37 or carrier groups 38.

The electronic unit 66 comprises on the one hand a speed-regulating unit 67 for at least one of the driven grill rollers 20, wherein, if all grill rollers 20 are driven as according to the exemplary embodiment according to FIG. 19, all grill rollers 20 are also correspondingly regulated, since the electronic unit 66 activates the motor 14. On the other hand, the electronic unit 66 comprises a temperature-regulating unit 68 for the heating unit 30, in that this is activated correspondingly to the desired temperature, in which case the measured results of the thermometer 40 are substantially definitive here.

Furthermore, the monitoring means 60 and input means 69 function as input variables in the electronic unit 66, wherein the input means 69 permit the indication of the nature of the product for grilling, for example whether fish, chicken, beef or pork.

In the exemplary embodiment illustrated in FIG. 20, a rotary switch functions as input means 69, in which case a key bar or a keyboard, a touch screen or similar may also be safely used.

The electronic unit also activates a display 65, which indicates on the one hand the selected product for grilling and on the other hand the attainment of a cleaning temperature. Alternatively thereto or cumulatively therewith, the attainment of the preset temperature for grilling, the current temperature or even other information, such as the options for selection of product for grilling, may also be indicated, or, as regards complex input options, so may also the instantaneous input.

### LIST OF REFERENCE SYMBOLS

10 Continuous grill
11 Housing
12 Discharge grate
13 Grilling gap
14 Motor
15 Grilling-gap varying means
16 Inlet
17 Outlet
18 Toothed drive gears
19 Feeder for product for grilling
20 Grill roller
21 Sub-roller
22 Sub-roller
23 Inside wall
28 Inner rotary bearing
29 Outer rotary bearing
30 Heating unit
31 Heating coil
32 Heating bar
33 Heating cartridge
34 Bearing point
35 Insulating layer
36 Insulating unit
37 Retaining bracket
38 Carrier group
39 Bearing journal
40 Thermometer
41 Resistance thermometer
42 Thermocouple
43 Color sensor
44 Color-changing area
51 Electrical terminal
52 Electrical terminal
57 Sub-housing
58 Sub-housing
59 Sub-housing
60 Monitoring means
61 Torque-sensing unit
62 Ultrasonic sensor
63 Pressure sensor
65 Display
66 Electronic unit
67 Speed-regulating unit
68 Temperature-regulating unit
69 Input means
70 Exhaust unit
71 Fan motor
72 Fan
73 Filter
74 Filter holder
75 Exhaust-air duct
76 Exhaust duct
81 Cleaning brush
82 Cleaning pad

1-37. (canceled)

38. A continuous grill (10) with at least two, preferably three grill rollers (20) forming at least one grilling gap (13), comprising an assembly that is capable of rotating relative to at least one grill roller (20) and that projects out of this grill roller (20) and/or projects into it, wherein an inner rotary bearing (28) is disposed between this grill roller (20) and this assembly and/or wherein this assembly is mounted on a housing (11) of the continuous grill (10) or on a carrier group (38) mounted immovably relative to the housing (11).

39. The continuous grill (10) according to claim 38, wherein an inner rotary bearing (28) is disposed, at both ends of the at least one grill roller (20), between this grill roller (20) and the assembly or a further assembly, capable of rotating relative to this grill roller (20), projecting out of it and/or projecting into it.

40. The continuous grill (10) according to claim 38, wherein the carrier group (38) comprises a retaining bracket (37).

41. The continuous grill (10) according to claim 38, wherein the assembly comprises a heating unit (30) and/or a thermometer (40) or a carrier element, especially for the heating unit (30) and/or the. thermometer (40).

42. The continuous grill (10) according to claim 38, wherein the at least one grill roller (20) is mounted rotatably via an outer rotary bearing (29) on a housing (11).

43. The continuous grill (10) according to claim 38, wherein at least one of the rotary bearings (28, 29) is a sliding bearing.

44. The continuous grill (10) according to claim 38, wherein the mounting takes place via an insulating unit (36), preferably via an insulating layer (37).

45. A continuous grill (10) with at least two, preferably three grill rollers (20) forming at least one grilling gap (13), comprising at least one electrically designed and/or locally measuring thermometer (40) disposed inside at least one of the grill rollers (20).

46. The continuous grill (10) according to claim 45, wherein the thermometer (40) is a resistance thermometer (41) or a thermocouple (42).

47. The continuous grill (10) according to claim 45, wherein the thermometer (40) comprises a color sensor (43) and a heat-sensitive color-changing area (44) on an inside wall (23) of the grill roller (20).

48. The continuous grill according to claim 41, wherein the thermometer (40) is attached on or in the heating unit (30).

49. The continuous grill (10) according to claim 48, wherein the heating unit (30) comprises a heating cartridge (33) disposed inside at least one of the grill rollers (20) and the thermometer (40) is attached on or in the heating cartridge (33).

50. A continuous grill (10) with at least two, preferably three grill rollers (20) forming at least one grilling gap (13), comprising at least one grill roller (20) coated with a non-stick coating or enameled.

51. The continuous grill (10) according to claim 50, wherein the non-stick coating is a Teflon@ coating, preferably with a color indicator.

52. The continuous grill (10) according to claim 38, comprising means (15) for varying the grilling gap (13).

53. A cooking method for cooking of products for grilling on a continuous grill (10) with at least two, preferably three grill rollers (20) forming at least one grilling gap (13), wherein (i) the speed of throughput of the product for grilling through the grilling gap (13) is regulated as a function of the type of product for grilling, of a roller contact pressure, of the size of the grilling gap (13) and/or of a temperature-measuring unit and/or wherein (ii) the temperature at least of one of the grill rollers (20) is regulated as a function of the type of product for grilling, of a roller contact pressure, of the size of the grilling gap (13) and/or of a speed of throughput of the product for grilling through the grilling gap (13).

54. The cooking method according to claim 53, wherein the temperature-measuring unit comprises a locally measuring thermometer (40) and/or heat-sensitive color-changing area (44).

55. The cooking method according to claim 53, wherein the type of product for grilling is indicated via an input means (69) provided on the continuous grill (10).

56. The cooking method according to claim 53, wherein the temperature at least of one of the grill rollers is electronically regulated.

57. The cooking method according to claim 53, wherein, before an end of the cooking process, at least one of the grill rollers (20) revolves without heating, if necessary with a reversal of direction, and a mechanical cleaning means, such as a cleaning sponge, a cleaning brush (81) or a cleaning pad (82) is passed along the grill roller (20) as it continues to revolve.

58. The cooking method according to claim 53, wherein a cleaning is performed only when a drop, preferably indicated by the continuous grill (10), has taken place below a cleaning temperature limit.
